(19) United States
(12) Patent Application Publication
(10) Pub. No.: US 2012/0186059 A1
(43) Pub. Date: Jul. 26, 2012

(54) TARGET FOR LARGE SCALE METROLOGY SYSTEM

(76) Inventors: Eric Peter Goodwin, Tucson, AZ (US); Daniel Gene Smith, Oro Valley, AZ (US)

(21) Appl. No.: 13/359,297

(22) Filed: Jan. 26, 2012

Related U.S. Application Data
(60) Provisional application No. 61/436,509, filed on Jan. 26, 2011.

(51) Int. Cl. B23Q 17/00; G01B 11/14

(52) U.S. Cl. 29/407.01; 356/620

(57) ABSTRACT

A target (16) for a metrology system (10) that monitors the position of an object (12) includes a target housing (18) and a detector assembly (20). The target housing (18) is substantially spherically shaped and includes a first detector region (218F). The target housing (18) includes a housing interior (228). A light beam (22A) impinging on the target housing (18) results in light energy within the housing interior (228). The detector assembly (20) includes a first detector (220A) secured to the first detector region (218F). The first detector (220β) generates a first signal when the light beam (22A) impinges on the target housing (18) that relates to the light energy within the housing interior (228).

### RELATED APPLICATION

The application claims priority on Provisional Application Ser. No. 61/436,509 filed on Jan. 26, 2011, entitled “Practical Spherical Detector for iGPS Target”. As far as is permitted, the contents of U.S. Provisional Application Ser. No. 61/436,509 is incorporated herein by reference.

### BACKGROUND

Large scale metrology systems are used to monitor the position of one or more objects during an assembly or manufacturing procedure. There are a number of other potential applications too, e.g., measuring an object that's already been built, and/or monitoring a change in some object during the course of some events. There is an ever increasing need to improve the accuracy and performance of the metrology system, reduce the cost of the metrology system, and simplify the design of the metrology system.

One type of a large scale metrology system utilizes one or more targets that include a faceted cylindrical shaped detector array. Unfortunately, such systems often require difficult calibrations and can have a wide range of off-axis effects. Additionally, with such systems that utilize faceted cylinder detector arrays, the effective detection point in space varies with azimuth and elevation angles in strange ways. Accordingly, it is desirable to develop a metrology system having improved accuracy and performance, with reduced costs and a simplified design that does not require difficult calibrations, does not experience off-axis effects, and does not experience variations in effective detection point based on the azimuth and elevation angles.

### SUMMARY

The present invention is directed to a target for a metrology system that monitors the position of an object. In certain embodiments, the target includes a target housing and a detector assembly. The target housing is positioned near the object. The target housing is substantially spherical shaped and can include a first detector region. The detector assembly includes a first detector that is secured to the first detector region. The first detector generates a first signal when the light beam impinges on the target housing.

As an overview, in certain embodiments, each target, as described in detail herein below, provides precise and accurate positional information of the target despite certain variations of the azimuth and elevation angles of the target. Additionally, the position of each target can be quickly and easily determined without the need for difficult and/or time-consuming calibrations. Accordingly, in utilizing such targets, the accuracy and performance of the metrology system can be improved. Further, the target is relatively simple and inexpensive to manufacture, align and maintain.

In one embodiment, the target housing further includes a second detector region that is spaced apart from the first detector region. In such embodiment, the detector assembly can further include a second detector that is secured to the second detector region. The second detector generates a second signal when the light beam impinges on the target housing. In one embodiment, the first signal and the second signal are combined e.g., the first signal and the second signal can be added and/or averaged, to form a detector signal.

In certain embodiments, the target housing includes a housing interior within a surface of the target housing. In such embodiments, the light beam impinging on the target housing results in light energy within the housing interior that impinges on the first detector. In one such embodiment, the light beam impinging on the target housing, i.e. impinging on the surface of the target housing, results in light energy being scattered within the housing interior. Moreover, at least a portion of the scattered light energy impinges on the first detector.

In an alternative embodiment, the target further comprises a conversion layer that is positioned substantially adjacent to the target housing. In this embodiment, the light beam impinging on the target housing is at a first wavelength. Further, the conversion layer converts the light beam so that the light energy within the housing interior is at a second wavelength that is different than the first wavelength.

In one embodiment, when the detector assembly further includes a second detector that is secured to the second detector region, the first detector generates the first signal when at least a first portion of the light energy within the housing interior impinges on the first detector, and the second detector generates a second signal when at least a second portion of the light energy within the housing interior impinges on the second detector.

In one embodiment, the target also includes a coating that is layered substantially adjacent to the target housing. For example, the coating can be adapted to transmit certain wavelengths of light.

The present invention is further directed toward a metrology system that monitors the position of an object, the metrology system comprising a transmitter that generates a moving fan beam, and the target as described above. The metrology system can further comprise a control system that (i) receives the first signal from the first detector, (ii) receives the second signal from the second detector, and (iii) identifies when the fan beam is directed toward a center of the target housing.

Additionally, the present invention is directed toward a target for a metrology system that monitors the position of an object. In certain embodiments, the target comprises a target housing and a detector assembly. The target housing is positioned near the object. The target housing includes a housing interior. A light beam impinging on the target housing results in light energy within the housing interior. The detector assembly includes a first detector that is coupled to the target housing. The first detector generates a first signal that relates to the light energy within the housing interior.

Further, the present invention is also directed to a method for monitoring the position of an object. Still further, the present invention is directed to a method for manufacturing a structure comprising the steps of producing the structure with a shaping apparatus based on design information; obtaining shape information of the structure by using the method as described above; and comparing the obtained shape information and the design information with a controller to generate a comparison result.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a perspective view of a metrology system having features of the present invention that monitors the position of an object;

FIG. 1B is a front view of a transmitter from the metrology system of FIG. 1A;

FIG. 1C is a perspective view of the transmitter of FIG. 1B;

FIG. 1D is a perspective view of the transmitter and a target of the metrology system of FIG. 1A;

FIG. 2A is a simplified side view of an embodiment of a target having features of the present invention;

FIG. 2B is another simplified side view of the target of FIG. 2A;

FIG. 3A is a simplified side view of another embodiment of a target having features of the present invention;

FIG. 3B is another simplified side view of the target of FIG. 3A;

FIG. 4 is a simplified side view of still another embodiment of a target having features of the present invention;

FIG. 5 is a simplified side view of yet another embodiment of a target having features of the present invention;

FIG. 6 is a simplified side view of still yet another embodiment of a target having features of the present invention;

FIGS. 7A-7C illustrate alternative simplified side views of a target as a light beam moves from left to right across and impinges upon a target housing of the target; and

FIG. 7D graphically illustrate the intensity of a detector signal received by a control system as the light beam moves from left to right across and impinges upon the target housing of the target illustrated in FIGS. 7A-7C;

FIG. 8 is a simplified block diagram of a structure manufacturing system usable with the present invention; and

FIG. 9 is a flowchart showing a processing flow of the structure manufacturing system illustrated in FIG. 8.

### DESCRIPTION

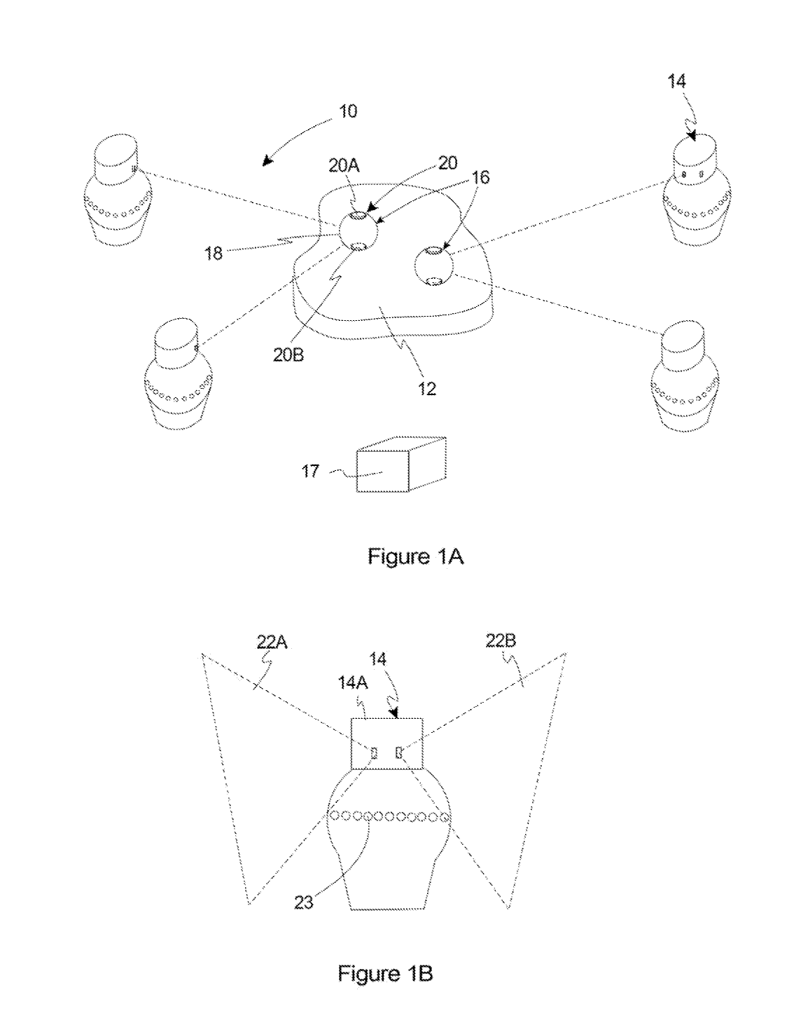

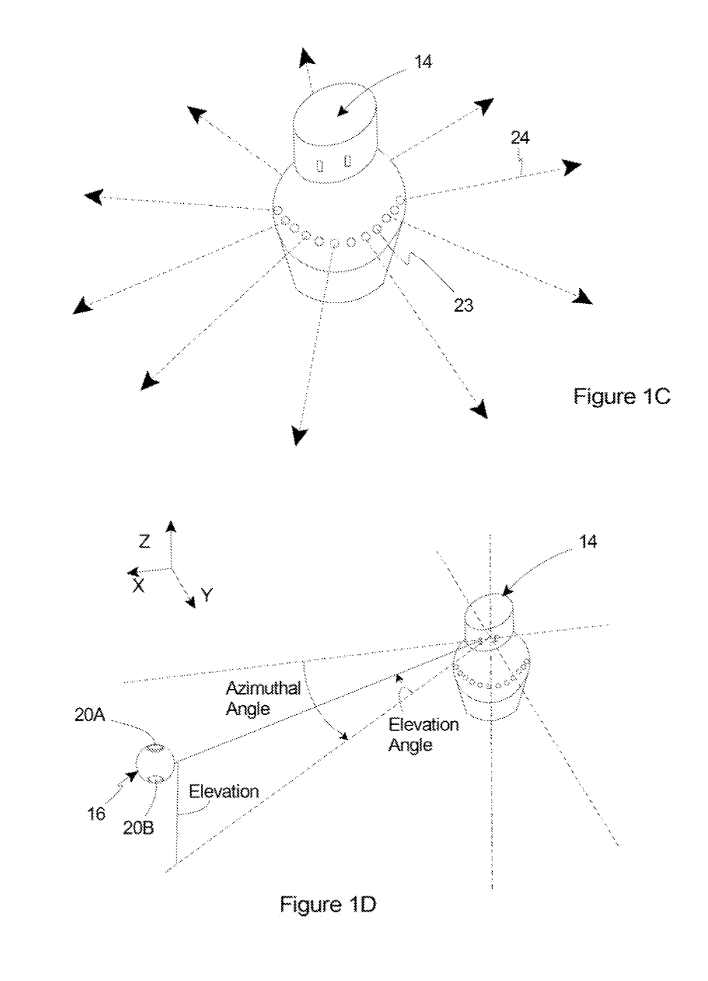

FIG. 1A is a perspective view of a metrology system 10 having features of the present invention. As shown, the metrology system 10 can be used for monitoring the position of one or more objects 12 (e.g., a mechanical structure). For example, in one embodiment, the metrology system 10 can be used for monitoring the position of the object 12 during a manufacturing or assembly process. Alternatively, the metrology system 10 can be adapted for use for other purposes.

The design of the metrology system 10 can be varied pursuant to the teachings provided herein. In the embodiment illustrated in FIG. 1A, the metrology system 10 includes (i) one or more transmitters 14, (ii) one or more targets 16 (two are illustrated in FIG. 1A) that are attached to the object 12, and (iii) a control system 17 that receives information from the targets 16 and determines the position of the targets 16 and the object 12 relative to the transmitters 14.

As an overview, in certain embodiments, each target 16 includes a target housing 18 and a detector assembly 20 having one or more detectors, e.g., a first detector 20A and a second detector 20B (illustrated in phantom), that are coupled to the target housing 18. With the unique design of the targets 16, as described in detail herein below, each target 16 is adapted to provide precise and accurate positional information of the target 16 despite certain variations of the azimuth and elevation angles of the target 16. Additionally, the position of each target 16 can be quickly and easily determined without the need for difficult and/or time-consuming calibrations. Accordingly, in utilizing such targets 16, the accuracy and performance of the metrology system 10 can be improved. Further, the target 16 is relatively simple and inexpensive to manufacture, align and maintain. A metrology system 10 having features of the present invention (without the improvements to the target 16) is sold by Nikon Metrology under the trademark “iGPS”.

In the embodiment illustrated in FIG. 1A, the metrology system 10 includes four spaced apart transmitters 14 that are used to determine the position of the targets 16 and the object 12. The position of each of the transmitters 14 is known. Thus, determining the position of the targets 16 and the object 12 relative to the transmitters 14 enables the determination of the position of the targets 16 and the object 12. Generally speaking, the positional accuracy improves as the number of transmitters 14 and targets 16 is increased.

FIG. 1B is a front view of one of the transmitters 14 illustrated in FIG. 1A. The design of the transmitters 14 can be varied to suit the specific requirements of the metrology system 10 (illustrated in FIG. 1A). In certain embodiments, the transmitter 14 can include a generator (not shown) that generates one or more light beams 22A, 22B that impinge on one or more of the targets 16 (illustrated in FIG. 1A) to determine the position of the one or more targets 16 relative to the transmitter 14. For example, in the embodiment illustrated in FIG. 1B, the transmitter 14 can include a fan beam generator (not shown) that generates one or more fan beams 22A, 22B that impinge on the targets 16 to determine the position of the object 12 relative to the transmitter 14. Alternatively, the light beams 22A, 22B can be other than the fan beams as illustrated herein.

In this embodiment, a head 14A of the transmitter 14 is rotating so that the fan beams 22A, 22B are moving, e.g., the fan beams 22A, 22B can move in a generally circular pattern so that the fan beams 22A, 22B can move or sweep across an outer surface of the targets 16 (illustrated in FIG. 1A). Further, each of the fan beams 22A, 22B are angled (e.g., tilted inward from top to bottom) such that the bottom of the fan beams 22A, 22B are much closer together than the top of the fan beams 22A, 22B.

Moreover, in one embodiment, the transmitter 14 includes a plurality of ports 23 and a strobe pulse generator (not shown) that generates an azimuthal strobe light pulse 24 (illustrated in FIG. 1C) once every revolution of the head 14A that is emitted from each of the ports 23. In certain embodiments, each of the light pulses 24 can have a wavelength of between approximately 750 nanometers and 1100 nanometers. More specifically, in some embodiments, each of the light pulses 24 can have a wavelength of between approximately 850 nanometers and 1000 nanometers. For example, in one embodiment, each of the light pulses 24 can have a wavelength of approximately 1000 nanometers. Alternatively, each of the light pulses 24 can have a wavelength of approximately 850 nanometers. Still alternatively, the light pulses 24 can have wavelengths that are different than the specific examples noted herein above. Additionally, in one embodiment, the light pulse 24 can have a wavelength such that the light pulse 24 is an infrared beam. As provided herein, in certain embodiments, the light pulse 24 is used to identify the particular transmitter 14.

Additionally, in certain embodiments, each of the light beams 22A, 22B can have a wavelength of between approximately 750 nanometers and 1100 nanometers. More specifically, in some embodiments, each of the light beams 22A, 22B can have a wavelength of between approximately 850 nanometers and 1000 nanometers. For example, in one embodiment, each of the light beams 22A, 22B can have a wavelength of approximately 785 nanometers. Alternatively, in one embodiment, each of the light beams 22A, 22B can have a wavelength of approximately 980 nanometers. Still alternatively, the light beams 22A, 22B can have wavelengths that are different than the specific examples noted herein above. Additionally, the wavelength of the light beams 22A, 22B can be substantially the same as or different from the wavelength of the light pulses 24.

Referring back to FIG. 1A, the control system 17 receives a first signal from the first detector 20A and a second signal from the second detector 20B. Subsequently, the control system 17 can combine the first signal and the second signal to form a detector signal. For example, in one embodiment, the first signal and the second signal are added together to form the detector signal. In another embodiment, the first signal and the second signal can be averaged together to form the detector signal. With this design, the control system 17 can individually determine when each beam 22A, 22B (illustrated in FIG. 1B) is incident on the target housing 18 of the target 16.

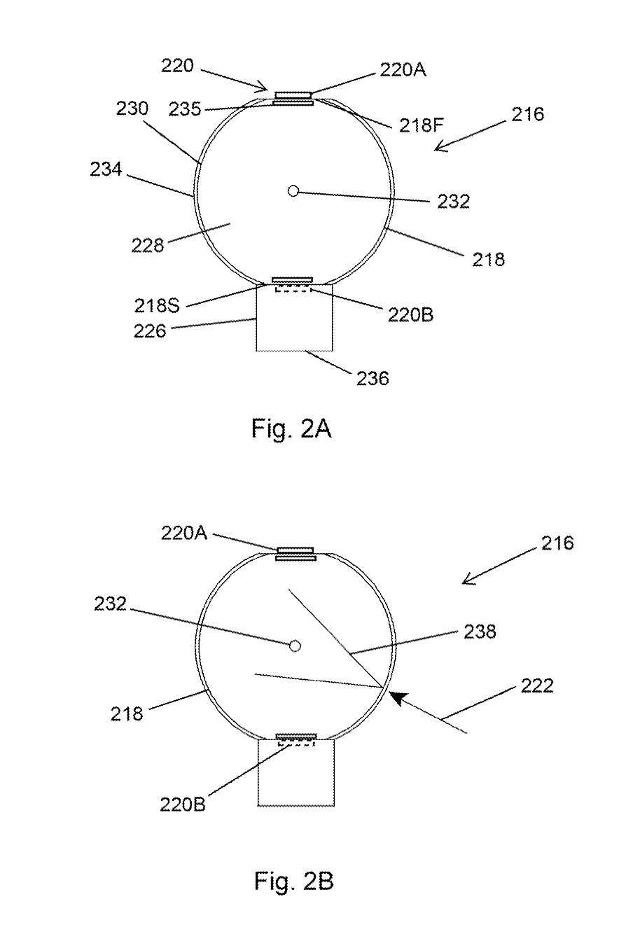

Additionally, as will be discussed in greater detail below, the control system 17 can individually determine when each beam 22A, 22B is normally incident on the target housing 18 of the target 16 as the detector signal will peak, i.e. will achieve its highest value, when the beam 22A, 22B is normally incident on the target housing 18. Moreover, as will be discussed in greater detail below, the beam 22A, 22B is normally incident on the target housing 18 when the beam 22A, 22B is directed through a center 232 (illustrated as a small circle, for example, in FIG. 2A) of the target housing 18. Further, the control system 17 controls the operation of each transmitter 14. The control system 17 can include one or more processors. In FIG. 1A, the control system 17 is illustrated as a centralized system positioned away from the other components. Alternatively, the control system 17 can be a decentralized system with processors positioned in the targets 16 and/or the transmitters 14.

It should be noted that the condition of the beams 22A, 22B being normally incident on the target housing 18 and/or having the beams 22A, 22B being directed through the center 232 of the target housing 18 is more readily achievable in embodiments that utilize fan beams 22A, 22B. Stated another way, because the fan beams 22A, 22B essentially constitute a sheet of light, the fan beams 22A, 22B can satisfy the desired condition of being normally incident on the target housing 18 for each beam 22A, 22B that impinges on the target housing 18.

FIG. 1C is a perspective view of the transmitter 14 illustrated in FIG. 1B. As illustrated, the transmitter 14 includes the plurality of ports 23 such that the azimuthal timing light pulses 24 are individually emitted from each of the ports 23 around the center circumference of the transmitter 14. It should be noted that in FIG. 1C, only a portion of the timing light pulses 24 is illustrated for purposes of clarity. Alternatively, in certain embodiments, an individual light pulse 24 may be emitted from only selected ports 23 and/or the transmitter 14 can have a different number of ports 23 and/or a different spacing between the ports 23 than that illustrated.

As provided herein, because the present invention can limit errors due to the variations in azimuth and elevation angles of the light beams 22A, 22B from the transmitter 14 relative to the targets 16, in certain embodiments it can be unnecessary to require the accurate determination of such angles during use. However, in some embodiments, to determine the position of the targets 16 and the object 12 (illustrated in FIG. 1A) with even greater precision, the control system 17 (illustrated in FIG. 1A) can further be utilized to determine the azimuth and elevation of the target 16 along a line relative to the transmitter 14.

For example, FIG. 1D illustrates one target 16 and one transmitter 14 of the metrology system 10 of FIG. 1A, where the one transmitter 14 can be used to determine the azimuth and elevation of the target 16 along a line relative to the transmitter 14. In this example, the target 16 is in the path of the beams 22A, 22B (illustrated in FIG. 1B) from the transmitter 14. Thus, the control system 17 can analyze the first signal from the first detector 20A and/or the second signal from the second detector 20B (illustrated in phantom) to determine the azimuth and elevation of the target 16. For example, in certain embodiments, the control system 17 can combine the first signal and the second signal to form the detector signal that can be used to determine the azimuth and elevation of the target 16. Alternatively, the control system 17 can be designed to only analyze the first signal from the first detector 20A or the second signal from the second detector 20B to determine the azimuth and elevation of the target 16.

In certain embodiments, the control system 17 can be used to determine the azimuth and elevation of a center 232 (illustrated, for example, in FIG. 2A) of each target housing 18 that is impinged upon by the light beams 22A, 22B.

As provided herein, the azimuth, or azimuthal angle, and elevation can be defined relative to a polar coordinate system, whose z-axis coincides with the rotation axis of the light beams 22A, 22B. The azimuthal plane, defined by z=0, is located approximately at the midpoint of the fan beams' vertical range. The azimuth is defined relative to the direction of the fan beams at the time of the azimuthal strobe light pulse 24 (illustrated in FIG. 1C). This direction also defines the direction of the x axis of a Cartesian coordinate system, whose z axis coincides with the z-axis of the polar coordinate system. The height, or elevation, of each target 16 relative to the azimuthal plane is determined from the time interval between arrival of the first light beam 22A at the center 232 of each target housing 18 and the arrival of the second light beam 22B at the center 232 of each target housing 18, as well as the vertical angle between the light beams 22A, 22B. The elevation angle e of the target 16 is given by e=arcsin(height/R), where R is the distance from the origin (sometimes referred to as the “range”) of the transmitter's polar coordinate system to the center 232 of the target housing 18.

Additionally and/or alternatively, more than one transmitter 14 may be needed to determine the range and other positional information of the target 16 and/or to improve the accuracy and precision of the determination of range and other positional information of the target 16.

Referring to FIGS. 1A-1D, with the present design, the metrology system 10 measures the distance to and orientation of mechanical structures 12. Targets 16 are mounted at specific locations on the mechanical structures 12. The distance from the center 232 of each target housing 18 to the contact position with the structure 12 is known, and the distance between targets 16 is also known. For each transmitter 14, the direction of the light beams 22A, 22B are known as a function of time. When the light beams 22A, 22B sweep across a target 16, it generates a signal whose time defines the direction of the light beams 22A, 22B (azimuth angle relative to the transmitter 14) when they impinge on the center 232 of the target housing 18. The time interval between the light beam pulses is used to determine the elevation angle relative to the transmitter 14. Based on these two angles from several transmitters 14, the position of the target 16 can be calculated with even greater precision.

FIG. 2A is a simplified side view of an embodiment of a target 216 having features of the present invention. The size and design of the target 216 can be varied depending on the requirements of the metrology system 10 (illustrated in FIG. 1A) and/or the object 12 (illustrated in FIG. 1A) to which the target 216 is attached. In the embodiment illustrated in FIG. 2A the target 216 includes a target housing 218, a detector assembly 220, and a housing support 226.

In this embodiment, the target housing 218 is solid and substantially spherical shaped and includes a housing interior 228 within a surface 230 of the target housing 218. Alternatively, in one embodiment, the target housing 218 can be hollow and substantially spherical shaped, and can include the housing interior 228. Still alternatively, other designs for the target housing may be utilized.

Additionally, in certain embodiments, the target housing 218 can be substantially transparent to certain wavelengths of light, i.e. lets certain wavelengths of light that impinge on the target housing 218 pass through the surface 230 of the target housing 218 into the housing interior 228, while reflecting other wavelengths of light. For example, in certain embodiments, the target housing 218 can be substantially transparent to the light beams 22A, 22B (illustrated in FIG. 1B) such that the light beams 22A, 22B impinging on the target housing 218 results in light energy within the housing interior 228. Moreover, in certain embodiments, the target housing 218 can be substantially transparent to the light pulses 24 (illustrated in FIG. 1C). For example, in some such embodiments, the target housing 218 can be made of glass, acrylic, transparent plastic, sapphire, opalescent glass, or another appropriate material that allows for the transmission of light from the light beams 22A, 22B and/or the light pulses 24 that impinges on the surface 230 of the target housing 218, while reflecting other light, e.g., atmospheric light.

Further, in certain embodiments, the target housing 218 can be between approximately ten millimeters and forty millimeters in diameter. Alternatively, the target housing 218 can have a diameter that is less than ten millimeters or greater than forty millimeters. For example, in certain alternative embodiments, increasing the size of the target housing 218 leads to more light collection and a higher signal for a given incident light level.

One advantage of the design provided herein is that the substantially spherical target housing 218 allows the control system 17 (illustrated in FIG. 1A) to determine a true point in space, i.e. a center 232 of the target housing 218, despite certain variations of the angle of incidence of the light beam 22A, 22B on the target housing 218. For example, by designing the target 216 to include a substantially spherical target housing 218 allows for a relatively simple determination of the position in space of the detector assembly 220, and thus the target 216, in three dimensions. The present invention, including the various embodiments described herein and any and all reasonably foreseeable alternatives, provides a practical, relatively simple optical system for detecting light from 360 degrees azimuth and +/−70 degrees in elevation with a single optical element, i.e. a single target 216.

As discussed herein, as a light beam 22A, 22B from the transmitters 14 (illustrated in FIG. 1A) strikes the target 216, the time-varying signal seen by the detector assembly 220 will be at a maximum when part of the incident wavefront of the fan-shaped light beam 22A, 22B is parallel to and/or coaxial with an axis coming from the center 232 of the target housing 218 to the surface normal of the target 216, i.e. to a point on the target housing 218 at which part of the light beam 22A, 22B is impinging on the target housing 218. Stated another way, when the light beam 22A, 22B is normally incident on the substantially spherical shaped target housing 218, the time-varying signal seen by the detector assembly 220 is at a maximum, which corresponds to the light beam 22A, 22B passing or being directed through the center 232 of the target housing 218, regardless of the incoming direction of the light beam 22A, 22B. Therefore, light from anywhere in the collection angle will have a maximum signal for the same point in the 3-D inspection volume, making calibration and correction very straightforward. The key is getting the light beam 22A, 22B that is incident on the target housing 218 incident on the detector assembly 220.

The detector assembly 220 can include one or more detectors that are secured to the surface 230 of the target housing 218. For example, in the embodiment illustrated in FIG. 2A, the detector assembly 220 includes two detectors, i.e. a first detector 220A and a second detector 220B (illustrated as a dashed box), that are coupled to the surface 230 of the target housing 218. Alternatively, in an embodiment that includes a hollow target housing 218, the detectors 220A, 220B can be coupled to an inner surface and/or an outer surface of the target housing 218.

Further, in this embodiment, the target housing 218 can include a first detector region 218F, and a spaced apart second detector region 218S. In one embodiment, both detector regions 218F, 218S are substantially flat and opposite to each other. In such embodiment, the target housing 218 can have the general shape of a truncated sphere. Alternatively, the detector regions 218F, 218S can have a different shape, e.g., a slightly curved shape, and/or the detector regions 218F, 218S can have a different positional relationship relative to one another.

Additionally, as illustrated in FIG. 2A, the first detector 220A can be secured to the first detector region 218F of the target housing 218, and the second detector 220B can be secured to the second detector region 218S of the target housing 218. Alternatively, the target housing 218 can be designed with only one detector region, or with more than two detector regions along the surface 230 of the target housing 218. Still alternatively, the detector assembly 220 can include more than two detectors or only one detector, and/or the detectors 220A, 220B can be secured to a different area on the target housing 218. Yet alternatively, in an embodiment that includes a hollow target housing 218, the detector regions 218F, 218S can be formed along the inner surface and/or the outer surface of the target housing 218.

It should be noted that by altering the target housing 218 slightly by flattening the opposing detector regions 218F, 218S of the target housing 218, i.e. by truncating the sphere, and attaching detectors 220A, 220B, e.g., photodiodes, to each detector region 218F, 218S provides the optical to electrical conversion that is necessary to get a useful signal out of the metrology system 10. For example, in certain embodiments, the first detector 220A of the detector assembly 220 that is secured to first detector region 218F of the target housing 218 generates a first signal that relates to the light energy that is present within the target housing 218 that impinges on the first detector 220A, i.e. the light energy that is present within the housing interior 228. More particularly, the first detector 220A generates the first signal when at least a first portion of the light energy within the housing interior 228 (a first portion of the light beam 22A, 22B) impinges on the first detector 220A. Additionally, the second detector 220B of the detector assembly 220 that is secured to the second detector region 218S of the target housing 218 generates a second signal that relates to the light energy that is present within the target housing 218 that impinges on the second detector 220B, i.e. the light energy that is present within the housing interior 228. More particularly, the second detector 220B generates the second signal when at least a second portion of the light energy within the housing interior 228 (a second portion of the light beam 22A, 22B) impinges on the second detector 220B.

Further, in one embodiment, the first signal and the second signal are combined to form a detector signal. Having two detectors 220A, 220B at opposing detector regions 218F, 218S of the target housing 218 means that the signal will not be biased for light beams 22A, 22B that are incident above or below a horizontal center line through the center 232 of the target housing 218, i.e. through the center of the sphere. Additionally, in one embodiment, a hole (not shown) can be drilled through the target housing 218 such that a wire (not shown) can be extended from the first detector 220A to the second detector 220B and into the housing support 226.

Additionally, the detector signal varies as the light beam 22A, 22B moves across the surface 230 of the target housing 218. In particular, as discussed above, the detector signal will be at a maximum when the light beam 22A, 22B is normally incident to the surface 230 of the target housing 218. As stated above, when the light beam 22A, 22B is normally incident on the surface 230 of the target housing 218, the light beam 22A, 22B is directed at and/or through the center 232 of the target housing 218, i.e. at and/or through the center 232 of the sphere within the housing interior 228.

It should be noted that when the light beams 22A, 22B are normally incident on the surface 230 of the target housing 218 above or below the horizontal center line through the center 232 of the target housing 218, i.e. closer to either detector region 218F, 218S, then the signal generated at one detector 220A, 220B and/or at one detector region 218F, 218S will be greater than the signal generated at the other detector 220A, 220B and/or other detector region 218F, 218S. Stated another way, in such conditions, one of the first signal and the second signal will be greater than the other signal. However, since, as noted above, the first signal and the second signal are combined to form the detector signal, the detector signal should be largely independent of the elevation angle of the normally incident beam 22A, 22B relative to the horizontal center line through the center 232.

In alternative embodiments, increasing the size of the target housing 218 leads to more light collection and a higher signal for a given incident light level. For example, in one embodiment, the light detection area (area on the surface 230 of the target housing 218 where the light beam 22A, 22B impinges on the surface 230 and which then results in light energy within the housing interior 228) can be quite large, but the area of the detectors 220A, 220B can be quite small, allowing the benefit of high sensitivity with small area detectors 220A, 220B. This also leads to an electrical advantage, as the smaller the size of the detectors 220A, 220B, the faster the response time without the need for high voltage circuitry for biasing the detectors 220A, 220B.

The design of each detector 220A, 220B can be varied. In certain embodiments, each detector 220A, 220B can be a photo sensitive detector. In this embodiment, each detector 220A, 220B is generally circular disk shaped. Alternatively, the detectors 220A, 220B can have a different design.

Additionally, in one embodiment, the target 216 can include a coating 234 that is layered on the surface 230 of the target housing 218. The coating 234 is designed to only transmit light having a certain wavelength or a certain range of wavelengths while reflecting light that is outside the certain wavelength or range of wavelengths. In certain embodiments, the coating 234 can be designed to filter out ambient light and/or to only transmit light having wavelengths that correspond to the wavelengths of the light beams 22A, 22B and the light pulses 24. In one embodiment, the coating 234 can be designed to only transmit light having a wavelength of approximately 980 nanometers. Alternatively, the coating 234 can be designed to transmit light of different wavelengths than specifically noted above. Still alternatively, the target 216 can be designed without the coating 234.

Additionally, or alternatively, to keep the unwanted light levels down, a chromatic filter 235 could be placed in front of the detectors 220A, 220B. The filter 235 can be designed to transmit light having wavelengths that correspond to the light energy that is generated within the housing interior 228 from the light beams 22A, 22B that are incident on the target housing 218 and the light pulses 24 that are incident on the target housing 218, and to reflect or absorb light that is different than the desired wavelengths. In another embodiment, detectors 220A, 220B could be utilized that are only sensitive to certain wavelengths of light, corresponding to the light energy that is generated within the housing interior 228 from the light beams 22A, 22B that are incident on the target housing 218 and the light pulses 24 that are incident on the target housing 218. Still alternatively, a window (not illustrated) may be placed in front of each detector 220A, 220B that only transmits certain wavelengths of light, corresponding to the light energy that is generated within the housing interior 228 from the light beams 22A, 22B that are incident on the target housing 218 and the light pulses 24 that are incident on the target housing 218.

The housing support 226 provides a means for securing the target 216 to the object 12 (illustrated in FIG. 1A). In one embodiment, the housing support 226 includes an engaging surface 236 (also referred to as a “mounting surface”) that engages a surface of the object 12 and is secured to the object 12. As shown in FIG. 2A, the housing support 226 can be secured to the target housing 218 substantially adjacent to one of the detectors, e.g., the second detector 220B, and/or substantially adjacent to one of the detector regions, e.g., the second detector region 218S, of the target housing 218. Alternatively, the housing support 226 can be secured to the target housing 218 in a different position. For example, in one such alternative embodiment, the housing support 226 can be secured to the target housing 218 substantially adjacent to the first detector 220A and/or substantially adjacent to the first detector region 218F of the target housing 218.

FIG. 2B is another simplified side view of the target 216 of FIG. 2A. More specifically, FIG. 2B illustrates a light beam 222, e.g., the first light beam 22A or the second light beam 22B illustrated in FIG. 1B, incident and/or impinging on the target housing 218, which results in light energy being scattered within the housing interior 228. Stated another way, the light beam 222 that is incident and/or impinges on the surface 230 of the target housing 218 can form a scattered beam array 238 within the housing interior 228.

It should be noted that the incident light beam 222 is illustrated as a simple arrow for purposes of clarity and it is not necessarily intended to represent the actual shape of the incident light beam 222.

In one embodiment, as noted above, the substantially spherical target housing 218 can be made from a glass material. However, in some instances, use of such material may result in limited light being allowed to make it to the detectors 220A, 220B, which may result in weaker signals being generated from the detectors 220A, 220B. Accordingly, a means for coupling the light energy from the incident light beam 222 to the detectors 220A, 220B (illustrated as a dashed box) can help to overcome any such limitations. One such approach, as illustrated in FIG. 2B, is to use a non-refractive approach such as through the use of scattering. For example, in one embodiment, the surface 230 of the target housing 218 can be textured so that the light beam 222 impinging on the target housing 218 results in light energy being scattered, i.e. the scattered beam array 238, within the housing interior 228. With this design, the incident light from the light beam 222, which comes in nominally at a single angle, is converted into light at a variety of angles. More specifically, with the scattering approach, the light energy, i.e. the scattered beam array 238, within the housing interior 228 is sent to a cone in angle space around the incident angle. By expanding the angle and/or direction of the light energy within the housing interior 228, sufficient light energy can then impinge on the detectors 220A, 220B to generate strong enough signals to effectively determine the position in space of the detector assembly 220, and thus the target 216, in three dimensions.

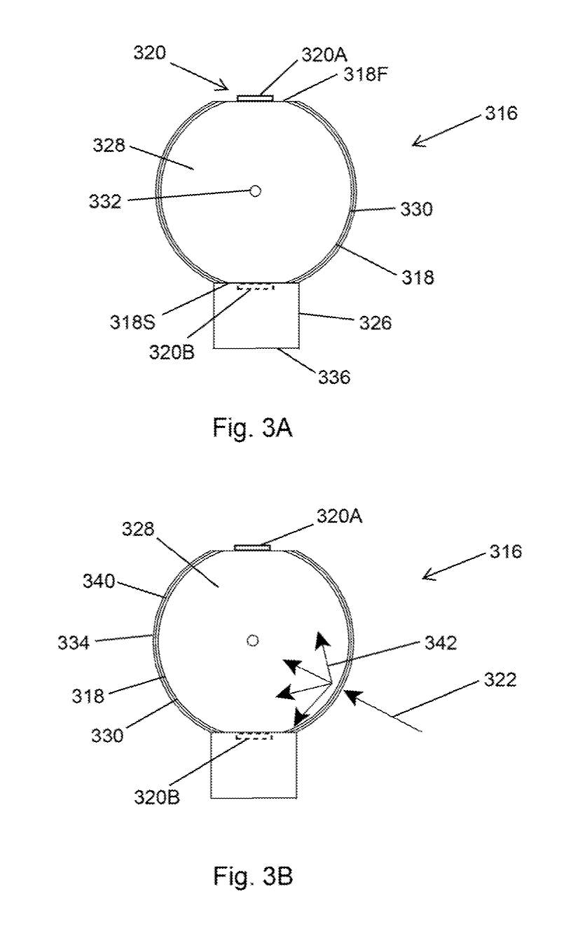

FIG. 3A is a simplified side view of another embodiment of a target 316 having features of the present invention. The target 316 illustrated and described in relation to FIG. 3A is somewhat similar to the target 216 illustrated and described in relation to FIG. 2A. For example, in this embodiment, the target 316 again includes a target housing 318, a detector assembly 320, and a housing support 326.

In this embodiment, the target housing 318 is again substantially spherical shaped and includes a housing interior 328 within the target housing 318. Additionally, in certain embodiments, the target housing 318 can be substantially transparent to the light beams 22A, 22B (illustrated in FIG. 1B) and the light pulses 24. Further, as illustrated, the target housing 318 can include a first detector region 318F, and a spaced apart second detector region 318S. In one embodiment, both detector regions 318F, 318S are substantially flat and opposite to each other.

The detector assembly 320 can include one or more detectors that are secured to a surface 330 of the target housing 318. For example, in the embodiment illustrated in FIG. 3A, the detector assembly 320 includes two detectors, i.e. a first detector 320A and a second detector 320B (illustrated as a dashed box), that are secured to the surface 330 of the target housing 318. With this design, as illustrated in FIG. 3A, the first detector 320A can be secured to the first detector region 318F of the target housing 318, and the second detector 320B can be secured to the second detector region 318S of the target housing 318.

As discussed herein, as a light beam 22A, 22B from the transmitters 14 (illustrated in FIG. 1A) strikes the target 316, the time-varying signal seen by the detector assembly 320 will be at a maximum when the incident wavefront of the light beam 22A, 22B is parallel to and/or coaxial with an axis coming from a center 332 (illustrated as a small circle) of the target housing 318 to the surface normal of the target 316, i.e. to a point on the target housing 318 at which the light beam 22A, 22B is impinging on the target housing 318.

During use, the first detector 320A of the detector assembly 320 that is secured to first detector region 318F of the target housing 318 generates a first signal that relates to the light energy that is present within the housing interior 328. More particularly, the first detector 320A generates the first signal when at least a first portion of the light energy within the housing interior 328 impinges on the first detector 320A. Additionally, the second detector 320B of the detector assembly 320 that is secured to the second detector region 318S of the target housing 318 generates a second signal that relates to the light energy that is present within the housing interior 328. More particularly, the second detector 320B generates the second signal when at least a second portion of the light energy within the housing interior 328 impinges on the second detector 320B. Further, in one embodiment, the first signal and the second signal are combined, e.g., added together or averaged together, to form a detector signal.

The housing support 326 provides a means for securing the target 316 to the object 12 (illustrated in FIG. 1A). In one embodiment, the housing support 326 includes an engaging surface 336 (also referred to as a “mounting surface”) that engages a surface of the object 12 and is secured to the object 12. As shown in FIG. 3A, the housing support 326 can be secured to the target housing 318 substantially adjacent to one of the detectors, e.g., the second detector 320B, and/or substantially adjacent to one of the ends, e.g., the second detector region 318S, of the target housing 318. Alternatively, the housing support 326 can be secured to the target housing 318 in a different position.

FIG. 3B is another simplified side view of the target 316 of FIG. 3A. More specifically, FIG. 3B illustrates that the target 316 can include a conversion layer 340 that is positioned substantially adjacent to the surface 330 of the target housing 318; and a coating 334 that is layered substantially adjacent to the conversion layer 340 and/or the target housing 318. In the embodiment illustrated in FIG. 3B, the conversion layer 340 is shown as being positioned substantially adjacent to the surface 330 of the target housing 318; and the coating 334 is shown as being layered on and/or substantially adjacent to an outer surface of the conversion layer 340. Alternatively, the coating 334 can be layered on and/or substantially adjacent to the surface 330 of the target housing 318; and the conversion layer 340 can be positioned directly adjacent to the coating 334.

Additionally, FIG. 3B illustrates a light beam 322, e.g., the first light beam 22A or the second light beam 22B illustrated in FIG. 1B, incident or impinging on the target housing 318, which results in light energy being fluoresced within the housing interior 328. Stated another way, the light beam 322 that is incident and/or impinges on the surface 330 of the target housing 318 can form a fluoresced beam array 342 within the housing interior 328. It should be noted that the incident light beam 322 is illustrated as a simple line for purposes of clarity and it is not necessarily intended to represent the actual shape of the incident light beam 322.

FIG. 3B illustrates a fluorescing approach, to overcome any limitations from the use of a glass material for the target housing 318. For example, in one embodiment, the light beam 322 that is directed toward the target housing 318 can be at a first wavelength. Additionally, the conversion layer 340 that is positioned substantially adjacent to the target housing 318 can be designed to convert the light beam 322 that impinges on the conversion layer 340 such that the light energy, i.e. the fluoresced beam array 342, within the housing interior 328 is at a second wavelength that is different than the first wavelength. With the fluorescing approach, the incident light from the light beam 322, which comes in nominally at a single angle, is converted into light at a variety of angles. More specifically, with the fluorescence approach, light is absorbed and then re-emitted at a longer wavelength into 4π steradians. By expanding the angle and/or direction of the light energy within the housing interior 328, sufficient light energy can then impinge on the detectors 320A, 320B to generate strong enough signals to effectively determine the position in space of the detector assembly 320, and thus the target 316, in three dimensions. One advantage of the fluorescence approach is that the wavelength filtering is almost automatic.

The design and positioning of the conversion layer 340 can be varied according to the specific requirements of the metrology system 10 (illustrated in FIG. 1A). In one embodiment, the conversion layer 340 can be formed from Erbium doped glass. For example, (Er3+) fused silica fiber optics can be excited most effectively at a fairly narrow 980 nm excitation wavelength. Erbium doped fibers are readily available due to the fiber optics communications industry and they are used to create stimulated emission and amplification of telecom wavelengths. If they are simply excited by 980 nm, they undergo a non-radiative decay into a lower energy state and then emit light energy via spontaneous emission at 1531 nm. The 1531 nm light energy that is re-emitted within the housing interior 328 will go in all directions. Much of this light energy will either be directly incident on the detectors 320A, 320B or will get there after one or more reflections substantially within the housing interior 328. Fabrication of the Erbium doped layer around the sphere could be done by wrapping a commercially available Erbium doped fiber core around a glass sphere. Then, the assembly could be heated until the fiber melts into a layer or shell of Erbium doped glass. Alternatively, the conversion layer 340 can be formed from a different material and the conversion layer 340 can function with light beams 322 having different wavelengths than those discussed herein above.

Additionally, as noted above, the target 318 can further comprise the coating 334 that is positioned substantially adjacent to the conversion layer 340 and/or the target housing 318. As with the previous embodiment, the coating 334 is designed to only transmit light having a certain wavelength or a certain range of wavelengths. Stated another way, only certain wavelengths or certain ranges of wavelengths of light are allowed to pass through the coating 334 so that the light beam 322 can impinge on the conversion layer 340 and the target housing 318. In certain embodiments, the coating 334 can be designed to filter out ambient light and/or to only transmit light having a wavelength that corresponds to the wavelength of the light beam 322. Moreover, if the coating 334 is insufficient to keep the unwanted light levels down, another chromatic filter (not shown) could be placed in front of the detectors 320A, 320B, or detectors 320A, 320B could be utilized that are only sensitive to certain wavelengths of light, corresponding to the light energy that is generated within the housing interior 328 from the light beam 322 that is incident on the target housing 318. In one embodiment, the coating 334 can be designed to only transmit light having a wavelength equal to the wavelength of the light beam 322. For example, in one embodiment, the coating 334 can be designed to only transmit light having a wavelength of approximately 785 nanometers. Alternatively, in one embodiment, the coating 334 can be designed to only transmit light having a wavelength of approximately 980 nanometers. Still alternatively, the coating 334 can be designed to transmit light of different wavelengths than those specifically noted above. Still alternatively, the target 316 can be designed without the coating 334. In order to allow for the proper deposition of the coating 334 adjacent to the conversion layer 340, a surface of the conversion layer 340 could be polished down to allow for such deposition of the coating 334.

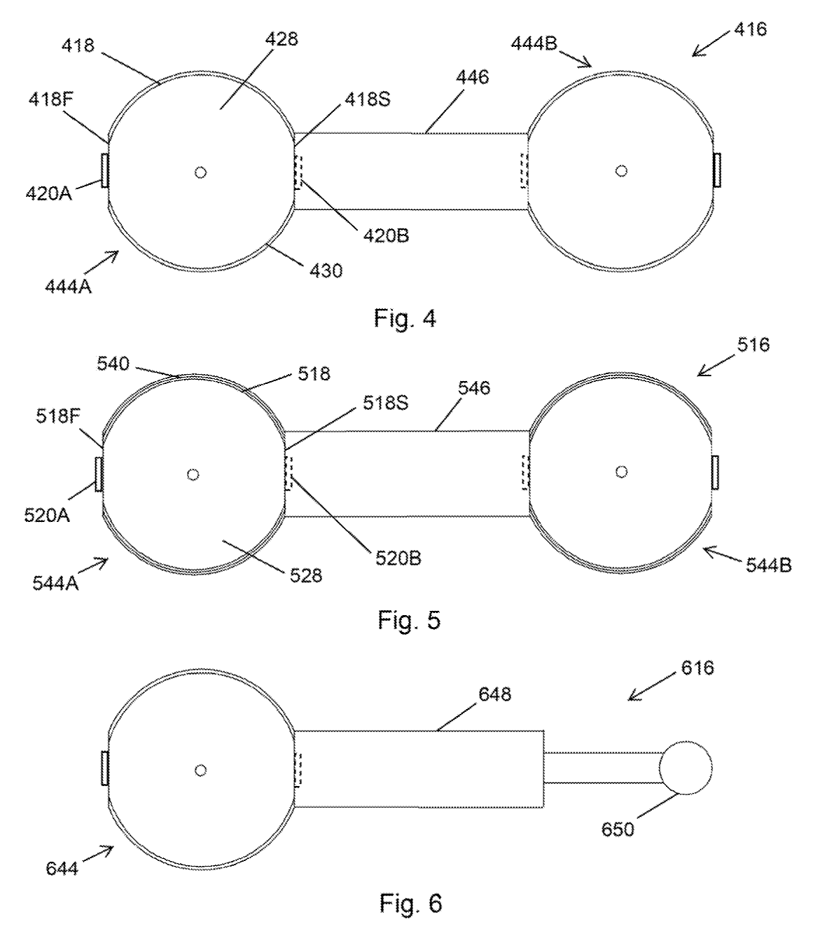

FIG. 4 is a simplified side view of still another embodiment of a target 416 having features of the present invention. In particular, FIG. 4 illustrates a “vector bar” type target 416. In this embodiment, the target 416 includes a left target subassembly 444A, a right target subassembly 444B, and a separator bar 446 that extends between and fixedly secures the subassemblies 444A, 444B together at a fixed, known distance.

In this embodiment, each subassembly 444A, 444B is substantially similar to the target 216 illustrated and described above in relation to FIGS. 2A and 2B. Additionally, the subassemblies 444A, 444B are substantially identical to one another. With this design, the target 416 illustrated in FIG. 4 includes two substantially spherical surfaces, i.e. target housings 418, with each target subassembly 444A, 444B including a target housing 418 having two detector regions 418F, 418S with an individual detector 420A, 420B (illustrated as a dashed box), respectively, secured to each detector region 418F, 418S. Additionally, in this embodiment, each of the target housings 418 includes a textured surface 430, such that a light beam, e.g., the first light beam 22A or the second light beam 22B illustrated in FIG. 1B, impinging on the surface 430 results in light energy being scattered within the housing interior 428.

With this design, the target 416 can be attached to the object 12 (illustrated in FIG. 1A) on either end of the target subassembly 444A, 444B that can function as an engaging surface. Further, with this design, the separator bar 446 or another part of the target 416 can be fixedly attached to the object 12. With this design, the light beams 22A, 22B from one of the transmitters 14 (illustrated in FIG. 1B) may impinge upon each of the target subassemblies 444A, 444B during movement of the light beams 22A, 22B over the target 416. Providing two target subassemblies 444A, 444B, such as described herein, separated by a known distance provides redundancy and greater accuracy in position determination.

FIG. 5 is a simplified side view of yet another embodiment of a target 516 having features of the present invention. In particular, FIG. 5 illustrates a “vector bar” type target 516. In this embodiment, the target 516 includes a left target subassembly 544A, a right target subassembly 544B, and a separator bar 546 that extends between and fixedly secures the subassemblies 544A, 544B together at a fixed, known distance.

In this embodiment, each subassembly 544A, 544B is substantially similar to the target 316 illustrated and described above in relation to FIGS. 3A and 3B. Additionally, the subassemblies 544A, 544B are substantially identical to one another. With this design, the target 516 illustrated in FIG. 5 includes two substantially spherical target housings 518, with each target subassembly 544A, 544B including a target housing 518 having two detector regions 518F, 518S with an individual detector 520A, 520B (illustrated as a dashed box), respectively, secured to each detector region 518F, 518S. Additionally, in this embodiment, each of the target subassemblies 544A, 544B includes a conversion layer 540 that is positioned about the target housing 518 such that a light beam, e.g., the first light beam 22A or the second light beam 22B illustrated in FIG. 1B, impinging on the conversion layer 540 results in light energy being fluoresced within the housing interior 528.

With this design, the target 516 can be attached to the object 12 (illustrated in FIG. 1A) on either end of the target subassembly 544A, 544B that can function as an engaging surface. Further, with this design, the separator bar 546 or another part of the target 516 can be fixedly attached to the object 12. With this design, the light beams 22A, 22B from one of the transmitters 14 (illustrated in FIG. 1B) may impinge upon each of the target subassemblies 544A, 544B during movement of the light beams 22A, 22B over the target 516. Providing two target subassemblies 544A, 544B, such as described herein, separated by a known distance provides redundancy and greater accuracy in position determination.

FIG. 6 is a simplified side view of still yet another embodiment of a target 616 having features of the present invention. In particular, FIG. 6 illustrates a “scepter” type target 616. In this embodiment, the target 616 includes a distal target subassembly 644, and a cantilevering bar 648 that cantilevers away from the distal target subassembly 644.

In this embodiment, the distal target subassembly 644 is substantially similar to the target 216 illustrated and described above in relation to FIGS. 2A and 2B. Alternatively, the distal target subassembly 644 can be substantially similar to the target 316 illustrated and described above in relation to FIGS. 3A and 3B. Still alternatively, the distal target subassembly 644 can have a different design.

In one non-exclusive embodiment, as illustrated in FIG. 6, a proximal bar tip 650 of the cantilevering bar 648 can be spherical shaped. With this design, the scepter target 616 can be manually positioned and held so that the proximal bar tip 650 functions as an engaging surface that selectively engages the object 12 (illustrated in FIG. 1A). In this design, the target 616 can be manually moved as a probe to selectively determine the position of one or more objects 12.

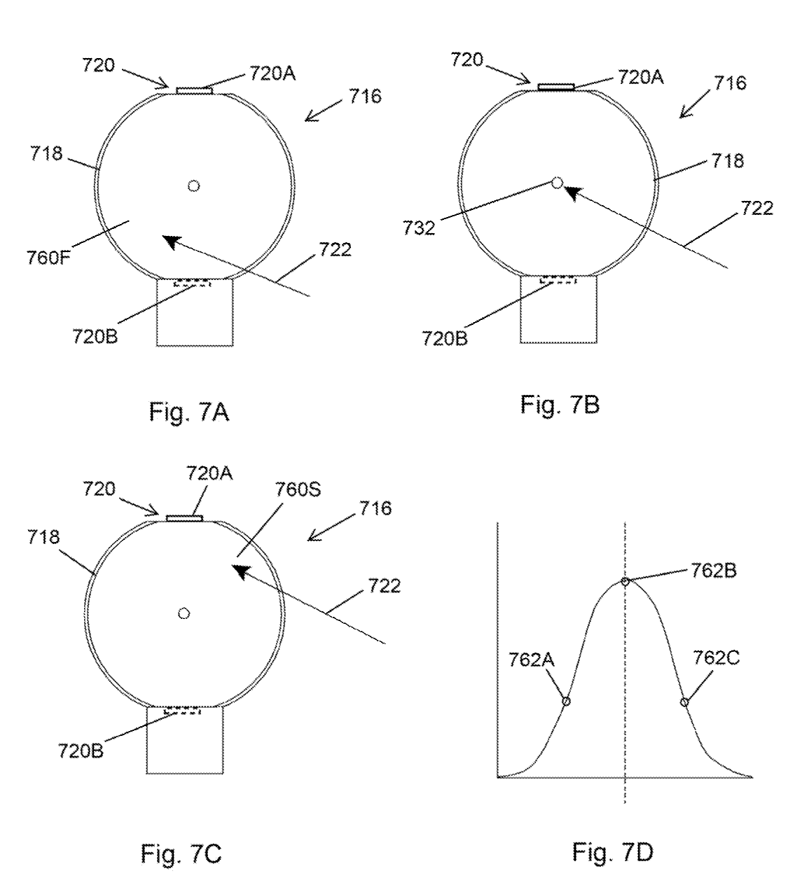

FIGS. 7A-7C illustrate alternative simplified side views of a target 716 as a light beam 722 moves from left to right across and impinges upon a target housing 718 of the target 716. More specifically, FIG. 7A illustrates the target 716 with the light beam 722 impinging upon a first side 760F of the target housing 718; FIG. 7B illustrates the target 716 with the light beam 722 being normally incident on the target housing, i.e. the light beam 722 being directed toward the center 732 of the target housing 718; and FIG. 7C illustrates the target 716 with the light beam 722 impinging upon a second side 760S of the target housing 718.

As provided above, when the light beam 722 impinges upon the target housing 718, the detector assembly 720 generates a detector signal (which, as provided above, can be formed by summing a first signal that is generated by the first detector 720A and a second signal that is generated by the second detector 720B (illustrated as a dashed box)). In particular, when the light beam 722 impinges on the first side 760F of the target housing 718, the detector assembly 720 generates a first detector signal 762A (graphically represented in FIG. 7D); when the light beam 722 is normally incident on the target housing 718, the detector assembly 720 generates a second detector signal 762B (graphically represented in FIG. 7D); and when the light beam 722 impinges on the second side 760S of the target housing 718, the detector assembly 720 generates a third detector signal 762C (graphically represented in FIG. 7D).

FIG. 7D graphically illustrates the intensity of the detector signals 762A, 762B, 762C received by a control system 17 (illustrated in FIG. 1A) as the light beam 722 moves from left to right across and impinges upon the target housing 718 of the target 716 illustrated in FIGS. 7A-7C. As shown in FIG. 7D, the curve generated by graphically illustrating the intensity of the detector signals 762A, 762B, 762C is a somewhat bell-shaped curve that demonstrates that the intensity of the detector signal 762A, 762B, 762C is at a maximum when the light beam 722 is normally incident on the target housing 718.

Additionally, with the unique design of the targets 16, as described in detail herein, precise and accurate positional information can be effectively determined for each target 16 despite certain variations of the azimuth and elevation angles of the target 16. Further, the position of each target 16 can be quickly and easily determined without the need for difficult and/or time-consuming calibrations.

Moreover, through the use of multiple targets 16 (or multiple target subassemblies) and/or through the use of multiple light beams 22A, 22B that each sweep across the targets 16, with a known timing interval between the light beams 22A, 22B and a known distance between each target 16 (or between each target subassembly), precise and accurate positional information can be effectively determined for the object 12 to which the targets 16 are attached.

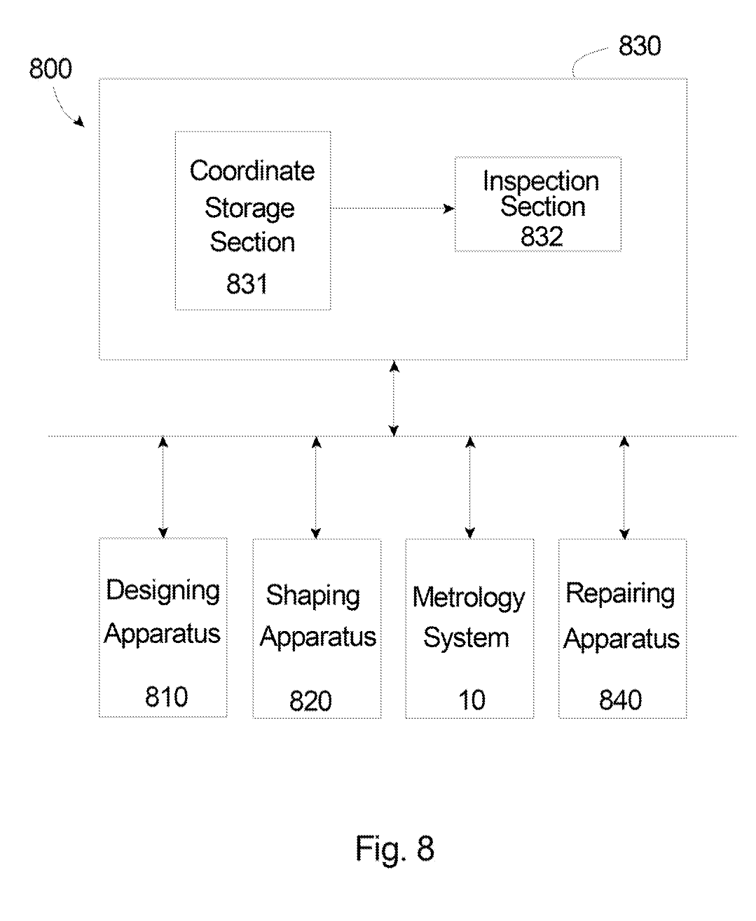

FIG. 8 is a simplified block diagram of a structure manufacturing system 800 usable with the present invention. In particular, the structure manufacturing system 800 can be utilized to manufacture a structure, e.g., a mechanical structure or object 12 (illustrated in FIG. 1A), utilizing the metrology the metrology system 10 illustrated and described in detail herein. In certain embodiments, the structure manufacturing system 800 can be utilized to produce at least one structure 12 from at least one construction such as a ship, an airplane, etc., and then to inspect the structure 12 with the metrology system 10.

The design of the structure manufacturing system 800 can be varied. In one embodiment, the structure manufacturing system 800 includes a designing apparatus 810, a shaping apparatus 820, a controller 830 having a coordinate storage section 831 and an inspection section 832, the metrology system 10, and a repairing apparatus 840. However, the present teaching is not limited to this particular configuration. For example, in one non-exclusive, alternative embodiment, as described herein, the structure manufacturing system 800 can be designed without the repairing apparatus 840 without limiting the intended scope and breadth of the present invention.

The designing apparatus 810 creates design information with respect to the shape of the desired structure 12 and send the created design information to the shaping apparatus 820. Additionally, the designing apparatus 810 further sends the created design information to the coordinate storage section 831 of the controller 830 so that the created design information can be stored within the coordinate storage section 831. The created design information includes specific information indicating the coordinates of each position or section of the structure 12.

The shaping apparatus 820 produces, i.e. shapes, the structure 12 based on the design information inputted from the designing apparatus 810. In certain embodiments, the shaping process undertaken by the shaping apparatus 820 can include such individual processes such as casting, forging, cutting, and the like. Additionally and/or alternatively, processes different than those specifically noted above may also be used by the shaping apparatus 820.

Once the shaping apparatus 820 has completed the desired shaping of the structure 12 according to the inputted design information, the metrology system 10, as described in detail herein above, is used to measure and/or detect the coordinates of the produced structure 12. The metrology system 10 then sends the measured shape information indicating the measured and/or detected coordinates of the produced structure 12 to the controller 830 so that the measured shape information can be stored within the controller 830. In one such embodiment, the metrology system 10 can send the measured shape information indicating the measured and/or detected coordinates of the produced structure 12 to the coordinate storage section 831 of the controller 830 so that the measured shape information can be stored within the coordinate storage section 831.

As noted above, the coordinate storage section 831 of the controller 830 stores the created design information from the designing apparatus 810. Additionally, as noted above, the measured shape information as measured and/or detected by the metrology system 10 is also sent to the controller 830. Subsequently, the inspection section 832 of the controller 830 reads out the created design information from the coordinate storage system 831 and compares that to the measured shape information provided by the metrology system 10. Based on the result of the comparison of the created design information and the measured shape information, the inspection section 832 determines whether or not the structure 12 is shaped in accordance with the created design information. Stated another way, the inspection section 832 determines whether or not the produced structure 12 is defective or nondefective. When the inspection section 832 determines that the structure 12 is not shaped in accordance with the design information, i.e. the structure is defective, the inspection section 832 then determines whether or not the structure 12 is repairable. If the inspection section 832 determines that the structure 12 is repairable, then the inspection section 832 calculates the defective portions and required repairing amount based on the comparison result. Subsequently, the inspection section 832 sends the information indicating the defective portions and required repairing amount to the repairing apparatus 840.

The repairing apparatus 840 performs processing on the defective portions of the structure 12 based on the information indicating the defective portions and required repairing amount received from the inspection section 832 of the controller 830. Once the repairing apparatus 840 has completed the necessary processing on the defective portions of the structure 12, the metrology system 10 can again be used to measure and/or detect the coordinates of the structure 12. The above process can be repeated as necessary. In certain alternative embodiments, for example those embodiments that do not include the repairing apparatus 840, once the inspection section 832 provides the information indicating the defective portions and required repairing amount for the structure 12, the shaping apparatus 820 can again be used to provide any necessary shaping of the structure 12.

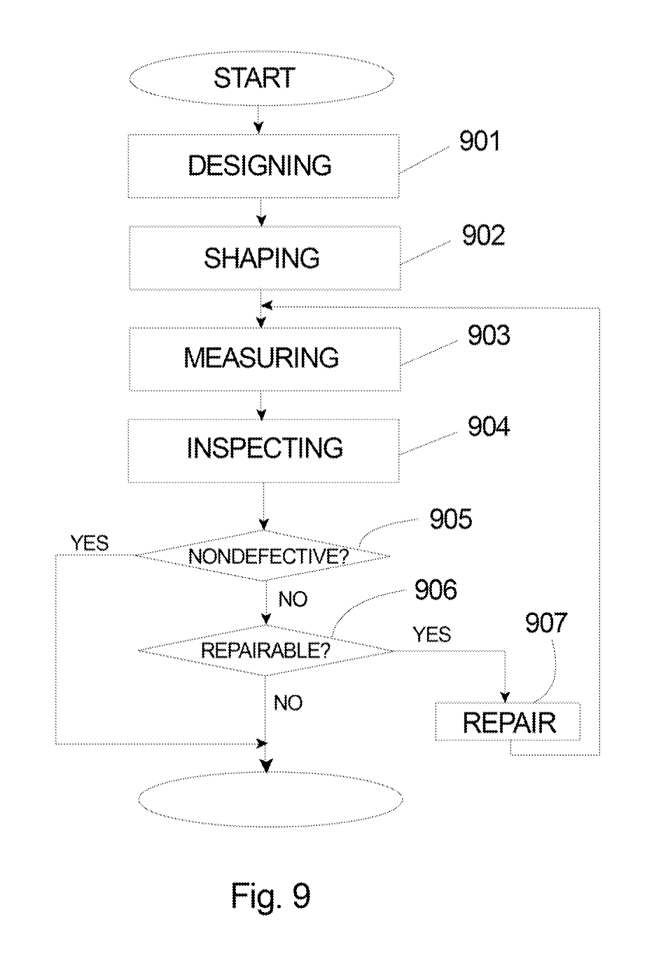

FIG. 9 is a flowchart showing a processing flow of the structure manufacturing system 800 illustrated in FIG. 8. Although it is disclosed that the steps employed in the structure manufacturing system 800 are performed in a certain order, it should be noted that the steps can be performed in a different order, and/or one or more of the steps can be combined or eliminated without altering the overall intended scope and breadth of the present invention.

Initially, in step 901 the designing apparatus creates design information with respect to the shape of a structure. Next, in step 902, the shaping apparatus produces the structure based on the design information. Then, in step 903, the metrology system measures the produced structure to obtain the shape information thereof. Subsequently, in step 904, the inspection section of the controller inspects whether or not the structure is produced truly in accordance with the design information by comparing the shape information obtained from the metrology system with the design information.

In step 905, the inspection section of the controller determines whether or not the produced structure is nondefective. When the inspection section has determined the produced structure to be nondefective, i.e. the inspection section answers “YES” at step 905, then the structure manufacturing system ends the process. On the other hand, when the inspection section has determined the produced structure to be defective, i.e. the inspection section answers “NO” at step 905, then, at step 906, the inspection section determines whether or not the produced structure is repairable.

If the inspection section determines that the produced structure is not repairable, i.e. the inspection section answers “NO” at step 906, then the structure manufacturing system ends the process. Alternatively, if the inspection section has determined the produced structure to be repairable, i.e. the inspection section answers “YES” at step 906, then, at step 907, the repairing apparatus carries out a reprocessing process on the structure. Alternatively, in embodiments that do not include the repairing apparatus, the repairing process may be performed by allowing the shaping apparatus to carry out the shaping process over again. In such a case, when the inspection section of the controller has determined the structure to be repairable, the shaping apparatus carries out the shaping process (forging, cutting, etc.) over again. In particular, for example, the shaping apparatus carries out a cutting process on the portions of the structure which should have undergone cutting previously, but have not. By virtue of this, it becomes possible for the structure manufacturing system to produce the structure correctly.

After the repairing, reprocessing and/or reshaping of the structure, the structure manufacturing system returns to step 903 to continue the process of the structure manufacturing system. Steps 903 through 907 are then repeated, as necessary, until the structure manufacturing system ends the process. With that, the structure manufacturing system finishes the whole process shown by the flowchart of FIG. 9.

With respect to the structure manufacturing system 800 as illustrated and describe herein, because the metrology 10 can be effectively utilized to correctly measure the coordinates of the structure, it is possible to determine whether or not the produced structure is nondefective. Further, when the structure is defective, the structure manufacturing system can carry out a reprocessing process on the structure to repair the same.

While a number of exemplary aspects and embodiments of a metrology system 10 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A target for a metrology system that monitors the position of an object, the metrology system including a transmitter that generates a light beam, the target comprising:
a substantially spherical target housing including a first detector region, the target housing being positioned near the object; and
a detector assembly including a first detector secured to the first detector region, the first detector generating a first signal when the light beam impinges on the target housing.

2. The target of claim 1 wherein the target housing includes a housing interior, and wherein the light beam impinging on the target housing results in light energy within the housing interior that impinges on the first detector.

3. The target of claim 2 wherein the light beam impinging on the target housing results in light energy being scattered within the housing interior, wherein at least a portion of the scattered light energy impinges on the first detector.

4. The target of claim 2 wherein the light beam impinging on the target housing is at a first wavelength, and further comprising a conversion layer that is positioned substantially adjacent to the target housing, the conversion layer converting the light beam so that the light energy within the housing interior is at a second wavelength that is different than the first wavelength.

5. The target of claim 2 wherein the target housing further includes a second detector region that is spaced apart from the first detector region, wherein the detector assembly further includes a second detector that is secured to the second detector region, wherein the first detector generates the first signal when at least a first portion of the light energy within the housing interior impinges on the first detector, and wherein the second detector generates a second signal when at least a second portion of the light energy within the housing interior impinges on the second detector, the first signal and the second signal being combined to form a detector signal.

6. The target of claim 1 further comprising a coating that is layered substantially adjacent to the target housing, the coating being adapted to transmit certain wavelengths of light.

7. A metrology system that monitors the position of an object, the metrology system comprising: a transmitter that generates a moving fan beam, the target of claim 1, and a control system that (i) receives the first signal from the first detector (ii) receives the second signal from the second detector, and (iii) identifies when the fan beam is directed toward a center of the target housing.

8. A target for a metrology system that monitors the position of an object, the metrology system including a transmitter that generates a light beam, the target comprising:
a target housing that includes a housing interior, wherein the light beam impinging on the target housing results in light energy within the housing interior, the target housing being positioned near the object; and
a detector assembly including a first detector that is coupled to the target housing, the first detector generating a first signal that relates to the light energy within the housing interior.

9. The target of claim 8 wherein a surface of the target housing is textured so that the light beam impinging on the target housing results in light energy being scattered within the housing interior.

10. The target of claim 8 wherein the light beam impinging on the target housing is at a first wavelength, and further comprising a conversion layer that is positioned substantially adjacent to the target housing, the conversion layer converting the light beam so that the light energy within the housing interior is at a second wavelength that is different than the first wavelength.

11. The target of claim 10 further comprising a coating that is layered substantially adjacent to at least one of the conversion layer and the target housing, the coating being adapted to transmit certain wavelengths of light.

12. The target of claim 8 wherein the detector assembly further includes a second detector that is secured to the target housing, wherein the first detector generates the first signal when at least a first portion of the light energy within the housing interior impinges on the first detector, and wherein the second detector generates a second signal when at least a second portion of the light energy within the housing interior impinges on the second detector, the first signal and the second signal being combined to form a detector signal.

13. The target of claim 12 wherein the target housing includes a first detector region and a spaced apart second detector region, and wherein the first detector is secured to the first detector region and the second detector is secured to the second detector region.

14. The target of claim 8 wherein the target housing is substantially spherical in shape.

15. A metrology system that monitors the position of an object, the metrology system comprising: a transmitter that generates a light beam, the target of claim 8, and a control system that receives the first signal from the first detector and identifies when light energy within the housing interior impinges on the first detector.

16. A method for monitoring the position of an object, the method comprising the steps of:
positioning a substantially spherical target housing near the object, the target housing including a first detector region;
securing a first detector to the first detector region; and
generating a first signal with the first detector when a light beam impinges on the target housing.

17. The method of claim 16 wherein the step of positioning includes the target housing including a housing interior, and wherein the step of generating includes the light beam impinging on the target housing resulting in light energy within the housing interior that impinges on the first detector.

18. The method of claim 17 wherein the step of generating includes the light beam impinging on the target housing resulting in light energy being scattered within the housing interior.

19. The method of claim 17 wherein the step of generating includes the light beam impinging on the target housing being at a first wavelength, and further comprising the steps of positioning a conversion layer substantially adjacent to the target housing, and converting the light beam with the conversion layer so that the light energy within the housing interior is at a second wavelength that is different than the first wavelength.

20. The method of claim 17 wherein the step of positioning includes the target housing including a second detector region that is spaced apart from the first detector region, and wherein the step of generating a first signal includes generating the first signal when at least a first portion of the light energy within the housing interior impinges on the first detector, and further comprising the steps of securing a second detector to the second detector region, and generating a second signal when at least a second portion of the light energy within the housing interior impinges on the second detector.

21. A method for manufacturing a structure, the method comprising the steps of:
producing the structure with a shaping apparatus based on design information;
obtaining shape information of the structure by using the method of claim 16; and
comparing the obtained shape information and the design information with a controller to generate a comparison result.

22. The method of claim 21 further comprising the step of reprocessing the structure based on the comparison result.

23. The method of claim 22 wherein the step of reprocessing the structure includes the step of producing the structure over again.

24. A method for monitoring the position of an object, the method comprising the steps of:
positioning a target housing near the object, the target housing including a housing interior, wherein a light beam impinging on the target housing results in light energy within the housing interior;
coupling a first detector to the target housing; and
generating a first signal with the first detector that relates to the light energy within the housing interior.

25. The method of claim 24 wherein the step of positioning includes the light beam impinging on the target housing resulting in light energy being scattered within the housing interior.

26. The method of claim 24 wherein the step of positioning includes the light beam impinging on the target housing being at a first wavelength, and further comprising the steps of positioning a conversion layer substantially adjacent to the target housing, and converting the light beam with the conversion layer so that the light energy within the housing interior is at a second wavelength that is different than the first wavelength.

27. The method of claim 24 wherein the step of generating a first signal includes at least a first portion of the light energy within the housing interior impinging on the first detector so that the first detector generates the first signal, and further comprising the steps of coupling a second detector to the target housing, and generating a second signal with the second detector that relates to the light energy within the target housing, at least a second portion of the light energy within the housing interior impinging on the second detector so that the second detector generates the second signal.

28. The method of claim 27 wherein the step of positioning includes the target housing being substantially spherical and including a first detector region and a spaced apart second detector region, wherein the step of coupling the first detector includes coupling the first detector to the first detector region, and wherein the step of coupling the second detector includes coupling the second detector to the second detector region.
